(19) United States
(12) Patent Application Publication
(10) Pub. No.: US 2006/0282254 A1
(43) Pub. Date: Dec. 14, 2006

(54) System and method for dealing with component obsolescence in microprocessor-based control units

(76) Inventors: John Ananny, San Francisco, CA (US); Michael Kaindl, Ergoldsbach (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/149,710

(22) Filed: Jun. 10, 2005

(51) Int. Cl. G06F 9/455

(52) U.S. Cl. 703/23

(57) ABSTRACT

A method of dealing with a microprocessor used in a first vehicle system control unit becoming obsolete. The method comprises providing a second vehicle system control unit for performing substantially the same operation as that of the first vehicle system control unit, wherein the second vehicle system control unit includes a microprocessor emulation unit having a programmable hardware device adapted to emulate the operation of the core functional portion of the microprocessor. The programmable hardware device may comprise a field programmable gate array (FPGA) device, a field programmable logic device (FPLD), a programmable logic array (PLA), a mask programmable logic device (MPLD), a programmable array logic (PAL) device, or a complex programmable logic device (CPLD). The microprocessor emulation unit may include substantially the same firmware and physical interface of the obsolete microprocessor.

### FIELD OF THE INVENTION

This invention relates generally to vehicle control systems, and in particular, to a system and method for addressing component obsolescence in microprocessor-based control units used in vehicle control systems.

### BACKGROUND OF THE INVENTION

The development, production, and post-production lifetime of a vehicle-type can span a relatively long time from a technological view point. For example, the development phase of a vehicle-type may span, for example, four (4) years or more; the production phase of a vehicle-type may span, for example, seven (7) years or more; and the post-production phase of a vehicle-type (whereby spare parts are needed to continue servicing vehicles) may span, for example, up to 10 to 15 years. During such lengthy lifetime, the continued availability and supply of electronic components that make up the vehicle control system are required to meet the demands of the development, production, and post-production phases of the vehicle-type.

Of particular interest is a microprocessor-based control unit used in a vehicle control system. Often vehicle control systems use control units that incorporate microprocessors to perform the various intended operations. Such operations include, for example, control of engine functions, control of automatic door and window operations, control of the vehicle navigation system, control of the vehicle anti-theft system, etc. Accordingly, the microprocessors used in such vehicle control units also generally need to have a life span equivalent to that of the vehicle-type, which may be more than 20 years. However, microprocessors typically have a relatively short life span before they becomes obsolete, for example, four (4) to five (5) years.

To reduce the risk related to microprocessor obsolescence, often vehicle manufacturers enter into long term agreements with manufacturers and/or suppliers of microprocessors for the continuous supply of a particular microprocessor-type for the lifetime of the vehicle-type. However, there is no guarantee that the manufacturers and/or suppliers will uphold the agreement. It may be more cost effective for the manufacturers and/or suppliers to breach the agreement and pay penalties and/or other damages due to the breach, than to continue to produce the particular microprocessor. Hence, there is no guarantee that the vehicle manufacturer will continue to have a continuous supply of the needed microprocessor.

Another technique that vehicle manufacturers use to address the problem with microprocessor obsolescence is to perform a re-design of the control unit which incorporates the obsolete microprocessor. The problem with this technique is that the re-designed control unit needs to undergo and successfully complete a new round of functional and verification tests. The functional and verification tests are typically performed by a vehicle testing and verification infrastructure. However, in old vehicle-types, such testing and verification infrastructure may no longer be available. Even with vehicle-types that still have the testing and verification infrastructure available, the expense to perform the testing and verification of the new vehicle system is usually high.

### SUMMARY OF THE INVENTION

An aspect of the invention relates to a method of dealing with a microprocessor used in a first vehicle system control unit becoming obsolete. The method comprises providing a second vehicle system control unit for performing substantially the same operation as that of the first vehicle system control unit, wherein the second vehicle system control unit includes a microprocessor emulation unit having a programmable hardware device adapted to emulate the core functional portion of the microprocessor. The programmable hardware device may comprise, for example, a field programmable gate array (FPGA), a field programmable logic device (FPLD), a programmable logic array (PLA), a mask programmable logic device (MPLD), a programmable array logic (PAL) device, or a complex programmable logic device (CPLD).

The microprocessor emulation unit may include substantially the same firmware as that of the microprocessor. Additionally, the microprocessor emulation unit may include substantially the same physical interface as that of the microprocessor. By keeping the firmware and physical interfaces substantially the same, testing and verification of the function of the replacement control unit at the vehicle system level may be avoided. Only the microprocessor emulation unit itself need be tested and verified, a task that is generally separate from and independent of any particular vehicle-type or vehicle-type-specific test infrastructure.

The microprocessor emulation unit may further include a voltage regulator to convert a power supply voltage appropriate for biasing the obsolete microprocessor to a voltage appropriate for biasing the programmable hardware device. Also, the microprocessor emulation unit may include a device for storing an emulation program (e.g., a compiled HDL program) for use by the programmable hardware device in emulating the operation of the core functional portion of the microprocessor. Further, the microprocessor emulation unit may include an interface for debugging and/or programming the programmable hardware device.

In one embodiment, the second vehicle control system includes a first PC board and a second PC board mounted on the first PC board, wherein the second PC board includes the microprocessor emulation unit. The second PC board may include a plurality of pins that mate with corresponding sockets on the first PC board. The pin configuration of the second PC board may be substantially the same as the pin configuration of the microprocessor. Alternatively, the second vehicle control system may include a PC board modified to include a plurality of sockets configured to mate with the pins of the microprocessor emulation unit.

Other aspects, features, and techniques of the invention will be apparent to one skilled in the relevant art in view of the following detailed description of the exemplary embodiments of the invention.

### BRIEF DESCRIPTION OF THE DRAWINGS

FIG. 1 illustrates a diagram of an existing microprocessor of a vehicle system control unit of a particular vehicle-type;

FIG. 2 illustrates a diagram of an exemplary microprocessor emulation unit as a replacement for the existing microprocessor in accordance with an embodiment of the invention;

FIG. 3 illustrates a diagram of an exemplary hardware implementation of a vehicle system control unit in accordance with another embodiment of the invention;

FIG. 4 illustrates a diagram of another exemplary hardware implementation of a vehicle system control unit in accordance with another embodiment of the invention; and

FIG. 5 illustrates a diagram of an exemplary vehicle control system in accordance with another embodiment of the invention.

### DETAILED DESCRIPTION OF THE EXEMPLARY EMBODIMENTS

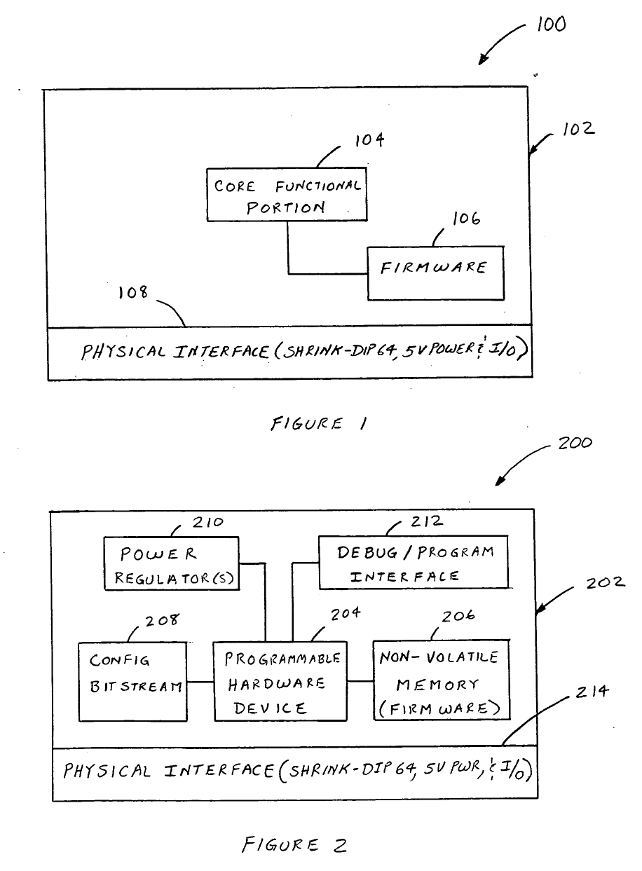

FIG. 1 illustrates a diagram of an existing microprocessor 100 of a vehicle system control unit of a particular vehicle-type. It shall be understood that the term “microprocessor” as used herein also includes microcontrollers, microcomputers, and other devices that execute software instructions. The existing microprocessor 100 is an example of a device that has become obsolete. In particular, the microprocessor 100 may include an integrated circuit 102 comprising a core functional portion 104, a firmware storage portion 106, and a physical interface 108. The core functional portion 104 performs the execution and processing of the software instructions. The firmware storage portion 106, which may be incorporated within the integrated circuit 102 or separate therefrom, stores instructions and data for initializing the core functional portion 104. The physical interface 108 serves as an interface for electrical connection to external components. The physical interface 108 may include, for example, a Shrink-DIP 64 connector including a pin to receive a power supply voltage (e.g., +5) and pins for input/output signals.

As discussed in the background section the lifetime of a vehicle-type, including its development, production, and post-production phases, may span more than 20 years. The microprocessor 100 may have a production lifespan of only four (4) to five (5) years. Thus, near the end of the production cycle of the microprocessor 100, the manufacturer of the vehicle-type needs to address the issue of the obsolete microprocessor 100 in order to continue supporting the vehicle type. The solution to the obsolete microprocessor 100 should not require testing and re-verification of the affected control unit at the vehicle system level because it will be probably be too time consuming and expensive, or in some situations, impractical due to the unavailability of the testing and re-verification infrastructure for the corresponding vehicle-type.

In summary, a solution to the obsolete microprocessor 100 in accordance with the invention is to replace the obsolete microprocessor with a microprocessor emulation unit having a programmable hardware device to emulate the core functional portion 104, and having a firmware and physical interface substantially the same as the firmware 106 and physical interface 108 of the microprocessor 100. Examples of programmable hardware devices include field programmable gate array (FPGA) devices, field programmable logic devices (FPLD), mask programmable logic devices (MPLD), programmable logic arrays (PLA), programmable array logic (PAL) devices, and complex programmable logic devices (CPLD). These programmable hardware devices typically comprise an array of interconnected logic cells (e.g., transistor pairs, logic gates, multiplexers, look-up tables (LUT), wide-fanin AND-OR structures) having interconnections that can be configured to achieve a desired operation, such as to emulate the operation of a specific microprocessor. A high level language, such as Hardware Description Language (HDL) or derivative thereof, is typically used to program the functionality of the programmable hardware devices.

As discussed above, the firmware 106 and physical interface 108 of the existing microprocessor 100 is maintained substantially the same in the new exemplary microprocessor emulation unit described below. The firmware is maintained substantially the same to avoid testing and re-verification of the firmware, which typically requires testing and verifying the operations of the affected control unit at the vehicle system level. As discussed in the Background Section, the testing and re-verification of the affected control unit at the vehicle system level can be substantially time-consuming, logistically complex, and expensive. And in some cases relating to old vehicle-types, the testing and re-verification infrastructure may no longer be available. Thus, by maintaining the firmware substantially the same as the firmware 106 of the existing microprocessor 100, testing and re-verification at the vehicle system level may be avoided. The only testing and verification that may be required is the emulation operation of the microprocessor emulation unit, which is independent of the vehicle-type or the vehicle-type-specific test infrastructure. The following illustrates an exemplary new microprocessor emulation unit in accordance with an embodiment of the invention.

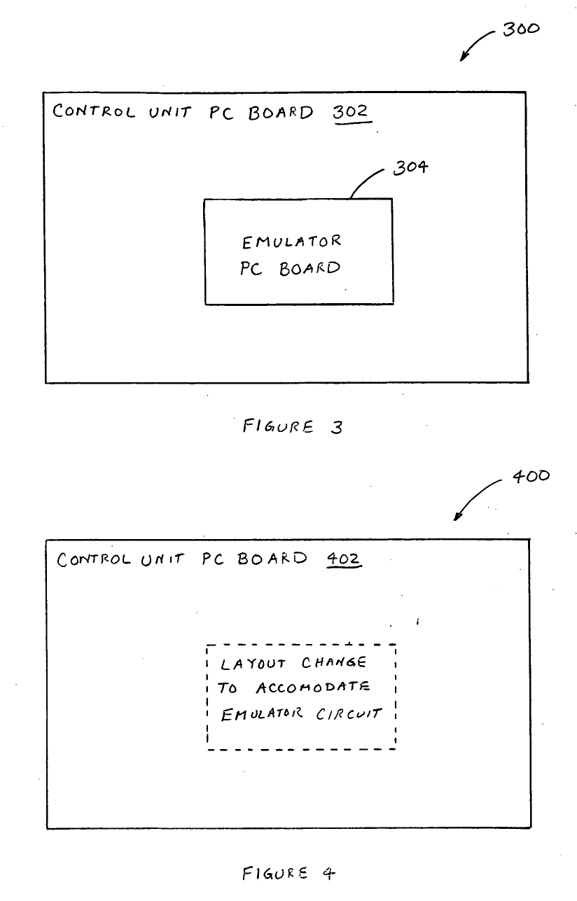

FIG. 2 illustrates a diagram of an exemplary microprocessor emulation unit 200 as a replacement for the existing microprocessor 100 in accordance with an embodiment of the invention. The microprocessor emulation unit 200 comprises a printed circuit (PC) board 202 including thereon a programmable hardware device 204, a non-volatile memory 206 (e.g., flash memory) serving as a storage for firmware substantially the same as firmware 106, a configuration bit stream storage device 208 for the programmable hardware device 204, a power regulator(s) 210, and a debug/program interface 212. The PC board 202 includes a physical interface 214 (e.g., Shrink-DIP 64, 5V Power, and I/O) to provide electrical connection to compo board 202.

As discussed above, the programmable hardware device 204 serves as an emulator for the core functional portion 104 of the obsolete microprocessor 100. The programmable hardware device 204 can be any programmable discrete logic devices including, for example, field programmable gate array (FPGA) devices, field programmable logic devices (FPLD), programmable logic arrays (PLA), mask programmable logic devices (MPLD), programmable array logic (PAL) devices, and complex programmable logic devices (CPLD). Typically, a high level language, such as HDL or derivative thereof, is used to program the programmable hardware device 204 in order to emulate the operations of the core functional portion 104 of the obsolete microprocessor 100.

As discussed above, the non-volatile memory 206 stores the firmware that embodies the system logic of the control unit. The firmware 206 is substantially the same as the firmware 106 of the microprocessor 100. As discussed above, the testing and re-verification of the new microprocessor emulation unit 200 at the vehicle system level may be avoided if the firmware 206 is maintained substantially the same as the old firmware 106. Additionally, the physical interface 214 of the PC board 202 is maintained substantially the same as the physical interface 108 of the microprocessor 100 to maintain compatibility with the existing vehicle system control unit.

The configuration bit stream device 208 includes the emulation program (e.g., in compiled HDL) used for configuring the programmable hardware device 204 to emulate the operations of the core functional portion 104 of the obsolete microprocessor 100. The configuration bit stream device 208 is used when the hardware programmable device 204 is of the type that can be programmed numerous times. Upon power up, the programmable hardware device 204 downloads the emulation program in order to configure itself to emulate the core functional portion 104 of the obsolete microprocessor 100. This sets up the dedicated logic circuits within the programmable hardware device 204 in order for it to perform the emulated operation.

The power regulator(s) 210 converts the power supply voltage used for the microprocessor 100 to a voltage more compatible with the programmable hardware device 204. For example, if the power supply voltage originally intended for the obsolete microprocessor 100 is five (5) volts, and the power supply voltage appropriate with the programmable hardware device 204 is 3.3 volts, the power regulator(s) 210 converts the five (5) volts to 3.3 volts. It shall be understood that the power supply voltage originally intended for the microprocessor 100 may be lower than the power supply voltage for the programmable hardware device 204. In such a case, the power regulator(s) 210 up converts the voltage.

The debug/program interface 212 may be optionally installed in the microprocessor emulation unit 200. It serves as an interface for programming, testing, and debugging the programmable hardware device 204. More appropriately, the debug/program interface 212 may be used in the development stage of the microprocessor emulation unit 200 to provide stimuli data to and receive test data from the programmable hardware device 204 to assist the developer with locating potential bugs in the emulation program, to verify performance of the programmable hardware device 204, and to reprogram the programmable hardware device 204 to eliminate program bugs. The following describes a couple of exemplary hardware implementations of a vehicle system control unit incorporating the microprocessor emulation unit 200 in accordance with other embodiments of the invention.

FIG. 3 illustrates a diagram of an exemplary hardware implementation of a vehicle system control unit 300 in accordance with another embodiment of the invention. The vehicle system control unit 300 comprises a main PC board 302 and a daughter PC board 304 serving as the microprocessor emulation unit 200. The main PC board 302 can be substantially the same as the PC board used by the existing vehicle system control unit including a socket configured to receive the obsolete microprocessor 100. The emulator PC board 304 may include the same pin configuration as that of the obsolete microprocessor 100 in order to properly mate with the corresponding socket of the main PC board 302. In this example, the layout of the main PC Board 302 need not be modified from the original layout accommodating the obsolete microprocessor unit 100. The following example may require a modification of the original layout of the main PC board.

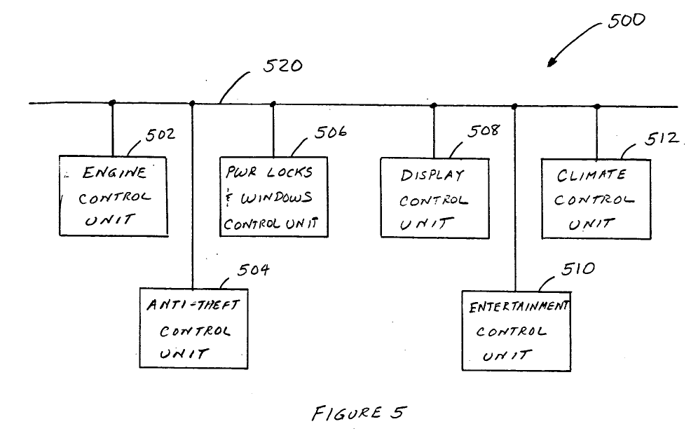

FIG. 4 illustrates a diagram of another exemplary hardware implementation of a vehicle system control unit 400 in accordance with another embodiment of the invention. In this example, the vehicle system control unit 400 comprises a PC board 402 having a layout that has been modified to accommodate the microprocessor emulation unit 200. Thus, in contrast to the prior example, the vehicle system control unit 400 only includes a single PC board, as oppose to an emulator PC board mounted on a main PC board.

FIG. 5 illustrates a diagram of an exemplary vehicle control system 500 in accordance with another embodiment of the invention. The vehicle control system 500 may comprise a plurality of control units, such as an engine control unit 502, an anti-theft control unit 504, a power locks and windows control unit 506, a display control unit 508, an entertainment control unit 510, and a climate control unit 512. The control units may be coupled to a common bus 520. Any one or more of these control units may be originally microprocessor-based. Accordingly, when the microprocessor of any of these control units becomes obsolete, the corresponding control unit may be modified to incorporate a microprocessor emulation unit as a replacement for the obsolete microprocessor, as discussed above.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of dealing with a microprocessor used in a first vehicle system control unit becoming obsolete, comprising providing a second vehicle system control unit for performing substantially the same operation as said first vehicle system control unit, wherein said second vehicle system control unit includes a microprocessor emulation unit having a programmable hardware device that emulates an operation of a core functional portion of said microprocessor.

2. The method of claim 1, wherein said programmable hardware device comprises a field programmable gate array (FPGA) device.

3. The method of claim 1, wherein said programmable hardware device comprises a field programmable logic device (FPLD).

4. The method of claim 1, wherein said programmable hardware device comprises a programmable logic array (PIA).

5. The method of claim 1, wherein said programmable hardware device comprises a mask programmable logic device (MPLD).

6. The method of claim 1, wherein said programmable hardware device comprises a programmable array logic (PAL) device.

7. The method of claim 1, wherein said programmable hardware device comprises a complex programmable logic device (CPLD).

8. The method of claim 1, wherein said first vehicle system control unit includes a memory device storing a first firmware for said microprocessor, and wherein said microprocessor emulation unit comprises a memory device storing a second firmware being substantially the same as said first firmware.

9. The method of claim 1, wherein said microprocessor includes a first physical interface, and wherein said microprocessor emulation unit comprises a second physical interface being substantially the same as said first physical interface.

10. The method of claim 1, wherein said microprocessor emulation unit comprises a voltage regulator adapted to convert a first voltage appropriate for biasing said microprocessor to a second voltage appropriate for biasing said programmable hardware device.

11. The method of claim 1, wherein said microprocessor emulation unit includes a memory device for storing an emulation program for use by said programmable hardware device in emulating said operation of said core functional portion of said microprocessor.

12. The method of claim 1, wherein said microprocessor emulation unit comprises an interface for testing, debugging and/or programming said programmable hardware device.

13. The method of claim 1, wherein said second vehicle system control unit includes a first printed circuit (PC) board and a second printed circuit (PC) board attached to said first printed circuit (PC) board, wherein said second printed circuit (PC) board includes said microprocessor emulation unit.

14. The method of claim 13, wherein second printed circuit (PC) board includes a plurality of pins that mate with corresponding sockets on said first printed circuit (PC) board.

15. The method of claim 14, wherein a pin configuration of said plurality of pins is substantially the same as a pin configuration of said microprocessor.

16. The method of claim 1, wherein said second vehicle system control unit includes a printed circuit (PC) board comprising a plurality of sockets configured to mate with a plurality of pins of said microprocessor emulation unit.

17. A first vehicle system control unit for replacing a second vehicle system control unit having a microprocessor, comprising a microprocessor emulation unit including a programmable hardware device adapted to emulate an operation of a core functional portion of said microprocessor of said second vehicle system control unit.

18. The first vehicle system control unit of claim 17, wherein said programmable hardware device comprises a field programmable gate array (FPGA) device.

19. The first vehicle system control unit of claim 17, wherein said programmable hardware device comprises a field programmable logic device (FPLD).

20. The first vehicle system control unit of claim 17, wherein said programmable hardware device comprises a programmable logic array (PLA).

21. The first vehicle system control unit of claim 17, wherein said programmable hardware device comprises a mask programmable logic device (MPLD).

22. The first vehicle system control unit of claim 17, wherein said programmable hardware device comprises a programmable array logic (PAL) device.

23. The first vehicle system control unit of claim 17, wherein said programmable hardware device comprises a complex programmable logic device (CPLD).

24. The first vehicle system control unit of claim 17, wherein said microprocessor emulation unit further comprises a memory device storing a first firmware that is substantially the same as a second firmware used by said microprocessor of said second vehicle system control unit.

25. The first vehicle system control unit of claim 17, wherein said microprocessor emulation unit further comprises a first physical interface being substantially the same as a second physical interface of said microprocessor of said second vehicle system control unit.

26. The first vehicle system control unit of claim 17, wherein said microprocessor emulation unit comprises a voltage regulator to generate a first voltage appropriate for biasing said programmable hardware device from a second voltage appropriate for biasing said microprocessor unit.

27. The first vehicle system control unit of claim 17, wherein said microprocessor emulation unit comprises a memory device for storing an emulation program for use by said programmable hardware device in emulating said operation of said core functional portion of said microprocessor.

28. The first vehicle system control unit of claim 17, wherein said microprocessor emulation unit comprises an interface for testing, debugging and/or programming said programmable hardware device.

29. The first vehicle system control unit of claim 17, comprising a first printed circuit (PC) board and a second printed circuit (PC) board attached to said first printed circuit (PC) board, wherein said second printed circuit (PC) board includes said microprocessor emulation unit.

30. The first vehicle system control unit of claim 29, wherein said second printed circuit (PC) board includes a plurality of pins that mate with corresponding sockets on said first printed circuit (PC) board.

31. The first vehicle system control unit of claim 30, wherein a pin configuration of said second printed circuit (PC) board is substantially the same as a pin configuration of said microprocessor.

32. The first vehicle system control unit of claim 17, comprising a printed circuit (PC) board including a plurality of sockets configured to mate with a plurality of pins of said microprocessor emulation unit.

33. A vehicle control system including a plurality of control units, wherein at least one of said control unit includes a programmable hardware device that emulates an operation of an obsolete microprocessor.

34. A microprocessor emulation unit to replace a microprocessor, comprising:
a programmable hardware device adapted to emulate an operation of a core functional portion of said microprocessor; and
a non-volatile memory including a first firmware substantially the same as a second firmware for said microprocessor.
